(19) United States
(12) Patent Application Publication
(10) Pub. No.: US 2011/0298692 A1
(43) Pub. Date: Dec. 8, 2011

(54) Variable geometry display module

(76) Inventors: Roel De Loore, Geel (BE); Marc Fichefet, Oostende (BE); Mario Hosten, Diksmuide (BE); Koenraad Maenhout, Kortrijk (BE); Rick Buskens, Teuven (BE); Simon Cleenewerck De Crayencour, Gent (BE); Domien Crevits, Lichtervelde (BE)

(21) Appl. No.: 13/201,759

(22) PCT Filed: Feb. 17, 2010
(86) PCT No.: PCT/EP10/51997

§ 371 Date: Aug. 16, 2011

(30) Foreign Application Priority Data
Feb. 17, 2009 (GB) 0902657.6

(51) Int. Cl. G09G 5/00

(52) U.S. Cl. 345/1.3

(57) ABSTRACT

Apparatus and methods for lighting and displays as well as to a display module for use in the lighting or displays are described. The display can have a variable geometry frame and the display does not require obscuring elements nor is it limited to being viewed from certain orientations. The display modules can have a front face, at least one light emitting and/or light reflecting surface, being arranged on the front side of the front face and covering a first partial area of said front face, and an anti-glare structure covering a second partial area of said front face. Furthermore, the invention relates to a display having a plurality of such display modules.

### FIELD OF THE INVENTION

The invention relates to apparatus and methods for lighting and displays as well as to a display module for use in the lighting or displays. The display can have a variable geometry frame and the display does not require obscuring elements. The display modules can have a front face, at least one light emitting and/or light reflecting surface, being arranged on the front side of the front face and covering a first partial area of said front face, and an anti-glare structure covering a second partial area of said front face. Furthermore, the invention relates to a display comprising a plurality of such display modules.

### TECHNICAL BACKGROUND OF THE INVENTION

A large number of displays such as advertisement billboards, sport event displays, video screens, theatre sets, concert displays, fashion show displays or other display devices utilizing light emitting diodes (LEDs) already exist on the market. The normal method of operation of such a display includes providing an electrical signal representing text or graphic data which are translated to control signals of the respective LEDs.

There is an interest to provide light walls for events that generate patterns of light and colours across a surface. An example of light wall is given on FIG. 20. Further, there is also an interest to generate non-flat light wall with a variable geometry, i.e. not necessarily cast once and for all in a given shape.

An example of a variable geometry light wall is shown in FIG. 20 and comprises a series of supports 100 for supporting lamps or lights e.g. LEDs or OLEDs that are fastened to a beam 110. Several such beams 110 may be used but for the sake of clarity a single beam 110 will be described in more detail. The beam 110 is made in a material and has such lateral dimensions that can it can be bent, i.e. it is made from a ductile material of which steel, aluminium, aluminium alloys, copper, copper alloys are example. A cable 120 can be used to exert a bending torque on the beam 110. The supports 100 will follow the beam 110 to which they are fastened and are spread around a cylindrical surface in a curve whose shaped is assumed by the beam 110 when bent. As shown in FIG. 21, the cable 120 require space and may have to be placed in front of the lights/lamps depending on the concavity/convexity that must be achieved for the light wall. Hence the cable is an obscuring element. Such a curved frame structure is also known from U.S. Pat. No. 4,953,329 which makes use of tension bars that can also obscure the lamps/lights for example when a concave surface is to be formed.

When operating such a display in an illuminated room or outside during the day, the problem arises that reflections of sunlight occur on the front face of the display module. This is even true for displays with light emitting devices embedded in black plastic material.

U.S. Pat. No. 7,336,195 discloses a light emitting array apparatus for use in a video screen display. This known panel provides a plurality of LEDs on the front face of the panel. In order to increase the contrast of the LEDs, the front face of the panel includes a plurality of louvers extending from the front face. An additional contrast enhancement for the LEDs may be obtained by providing intermediate of the main louvers micro-louvers.

However, shading the LEDs by louvers has the adverse effect that the viewing angle is restricted. Therefore, the display device has to be placed in one fixed orientation with respect to the audience. Furthermore, the number of onlookers is restricted by the emission angle of the display module and additional displays might be needed in order to reach a large audience. Louvers are obscuring elements.

### SUMMARY OF THE INVENTION

An object of the present invention is to provide a variable geometry frame structure that can support lamps/lights or other display elements and that does not need obscuring elements and is not restricted to viewing in preferred orientations. Cables or tension bars are obscuring elements that the present invention can avoid. Louvers are a further obscuring element that the present invention can avoid.

A further object of the present invention is to provide apparatus and methods for lighting and displays as well as a display module comprising a front face, at least one light emitting and/or light reflecting surface, being arranged on the front side of the front face and covering a first partial area of said front face, and an anti-glare structure covering a second partial area of said front face.

The present invention provides in one aspect a type of light wall whose shape may easily be determined after it has left the factory.

An advantage of embodiments of the present invention relates to a display module and a display apparatus supported on a frame that may have a variable geometry thus providing a more interesting viewing landscape and is not restricted to viewing in preferred orientations.

An alternative advantage of embodiments of the present invention relates to a display module and a display apparatus that may be used in a brightly lit environment, i.e. it has a non-reflective front face, and still provides an increased viewing angle.

According to a first embodiment of the invention, a display module is provided, comprising a front face, at least one light emitting and/or light reflecting surface being arranged on the front side of the front face and covering a first partial area of said front face. Additionally, the display module comprises an anti-glare structure covering a second partial area of said front face. The anti-glare structure according to this embodiment comprising a plurality of dome-shaped members protruding from the front face. Preferably all of said dome-shaped members have a diameter ranging from 1.0 mm up to 3.0 mm. In a preferred embodiments all of the dome-shaped members have one same size that has a diameter ranging from 1.0 mm up to 3.0 mm.

In another embodiment of the invention, the invention relates to a display apparatus comprising a plurality of display modules, wherein any of said display modules comprises a front face, at least one light emitting and/or light reflecting surface being arranged on the front side of the front face and covering a first partial area of said front face. Additionally, any display module comprises an anti-glare structure covering a second partial area of said front face. The anti-glare structure according to this embodiment comprises a plurality of dome-shaped members protruding from the front face. Preferably any of said dome-shaped members has a diameter ranging from 1.0 mm up to 3.0 mm.

The present invention provides an arrangement of a plurality of articulated display modules including a first and second display module, the first display module comprising:
a main body,
a hinged connection for connecting to the adjacent second display module,
a first locking mechanism for allowing the first display module to have a settable first orientation with respect to the second display module and for locking the first orientation between the first and second display modules; and
a connection for a display element.

The hinged connection allows rotation around a first axis and the main body includes a first part and a second part, the first part being rotatable about a second axis with respect to the first part, the second axis being perpendicular to the first axis. A second locking mechanism may be provided for allowing the first part to have a settable second orientation with respect to the second part and for locking the second orientation between the first and second parts. Preferably each display element includes a DC-DC converter so that the current in cables for powering the display element can be reduced.

The present invention also provides an arrangement for a plurality of display elements, comprising:
a first flexible strip having connections for the display elements, the first flexible strip having two ends,
a second flexible elongate element having two ends attached to the two ends of the first flexible strip,
means for changing the length of the second flexible elongate element between the attached two ends.

The arrangement preferably has a series of guide elements for constraining the second flexible elongate element to be parallel to the first flexible strip.

The means for changing the length is optionally a turnbuckle or bottlescrew.

A display element for use with the arrangement preferably includes a DC-DC converter.

At least some of the arrangements described above can be delivered in long lengths, e.g. on drums and can be cut to length on site and then customised as to their physical shape, e.g. one or more curvatures. Hence, the present invention also includes a method of modifying an arrangement of a plurality of articulated display modules including a first and second display module, the first display module comprising:
a main body,
a hinged connection for connecting to the adjacent second display module,
a first locking mechanism for allowing the first display module to have a settable first orientation with respect to the second display module and for locking the first orientation between the first and second display modules; and
a connection for a display element, the method comprising
setting the first orientation and locking it,
connecting a third display module to the second display module.

The method can also include attaching a display element to the associated connection for the display element on any of the first to third display modules.

The method also includes connecting up power and/or data cables to the display elements.

The main body of the display module may also include a first part and a second part, the hinged connection allowing rotation around a first axis and the first part being rotatable about a second axis with respect to the first part, the second axis being perpendicular to the first axis, the method may include setting the first part at an orientation with respect to the second part.

The display module may also have a second locking mechanism provided for allowing the first part to have a settable second orientation with respect to the second part and the method includes locking the second orientation between the first and second parts.

The plurality of display modules can be delivered in a chain of display modules and the method comprises cutting the chain to a reduced number of display modules.

This and other aspects of the invention will be apparent from and elucidated with reference to the embodiments described hereinafter.

### BRIEF DESCRIPTION OF THE DRAWINGS

In the drawings:

FIG. 1 illustrates a display module according to one embodiment of the invention.

FIG. 2 illustrates an anti-glare structure according to a first embodiment.

FIG. 3 illustrates an anti-glare structure according to a second embodiment.

FIG. 4 illustrates an anti-glare structure according to a third embodiment.

FIG. 5 illustrates three examples of possible arrangements of light emitting diodes for use in a display module according to the invention.

FIG. 6 illustrates possible arrangements of light emitting diodes according to another embodiment of the invention.

FIG. 7 illustrates a display apparatus according to the invention.

FIG. 8 illustrates a display arrangement in accordance with another embodiment of the present invention.

FIG. 9 illustrates a detail of the display arrangement in accordance with FIG. 8.

FIG. 10 illustrates a further detail of the display arrangement in accordance with FIG. 8.

FIG. 11 illustrates a display arrangement in accordance with another embodiment of the present invention.

FIG. 12 illustrates a display arrangement in accordance with another embodiment of the present invention.

FIG. 13 illustrates the display arrangement in accordance with the embodiment of FIG. 12.

FIG. 14 illustrates a main body part of a display arrangement in accordance with another embodiment of the present invention.

FIGS. 15 to 17 illustrate the display arrangement according to FIG. 14.

FIG. 18 illustrates a display arrangement in accordance with another embodiment of the present invention.

FIG. 19 illustrates a detail of a display arrangement in accordance with FIG. 18.

FIG. 20 illustrates a detail of a display arrangement.

FIG. 21 illustrates a detail of a display arrangement.

### DESCRIPTION OF THE ILLUSTRATIVE EMBODIMENTS

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes.

Furthermore, the terms first, second, third and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

Similarly, it is to be noticed that the term “coupled”, also used in the claims, should not be interpreted as being restricted to direct connections only. Thus, the scope of the expression “a device A coupled to a device B” should not be limited to devices or systems wherein an output of device A is directly connected to an input of device B. It means that there exists a path between an output of A and an input of B which may be a path including other devices or means.

When lighting or display modules are fixed to a frame with a variable geometry, the module can end up in any orientation to the viewer depending on its position on the frame. Ideally, the contrast of each module should be as high as possible and hence the contrast should be the same as viewed from any direction. However common methods of improving contrast such as louvers for making the background to the lighting module as dark as possible impose restrictions on the angle of view. First of all embodiments of the present invention that relate to methods and apparatus for improving contrast when viewed from many different viewing angles will be described that can be used with the variable geometry frames according to the present invention. Also lighting modules with optimally placed lighting units that can be viewed from many viewing angles will be described before describing the variable geometry frames themselves.

FIG. 1 illustrates a display module 100 according to one embodiment of the present invention. The display module 100 comprises a base material 110. The base material 110 may be made from a plastics material such as polypropylene, polyethylene, polycarbonate, fibre reinforced resin, or the like. The base material 110 is preferably non-transparent. In particular, the base material 110 is black. In order for the base material 110 to be non-transparent, the plastics material may comprise a pigment or dye such as a carbon black or nigrosine. The basic shape of the base material 110 may be obtained by means of a moulding process, e.g. injection, transfer moulding. However, in other embodiments of the invention the basic shape may be obtained by means of different methods such as rotational moulding.

The outer shape of the base material 110 and therefore the outer shape of the display module depicted in FIG. 1 is basically round. However, this is only an exemplary embodiment of the invention and in no way limiting. The basic material 110 has a front face 160 which is indented to be visible to the audience when operating the display module 100.

The front face 160 is divided into a first partial area which accommodates at least one light emitting and/or a light reflecting surface 130. As an example, a light emitting surface 130 may be obtained by means of an incandescent lamp, a halogen lamp, a light emitting diode, an organic light emitting diode, a gas discharge cell, or the like. In other embodiments of the invention, the light reflecting surface 130 may be provided. A light reflecting surface may be formed by means of a metallization layer or a light reflecting dye such as white coloured dyes. A light reflecting surface 130 may reflect light provided by a laser beam or a lamp which is focused or collimated onto the light reflecting surface 130 and reflected to the audience in order to present a viewable image.

According to one embodiment of the invention, any of the light emitting and/or a light reflecting surfaces 130 may represent one different pixel of an image displayed on the display module 100. In another embodiment of the invention, all light emitting and/or a light reflecting surfaces 130 arranged on a single display module are intended to represent one single pixel of an image, i.e. each display module 100 is adapted to display one pixel of an image. To achieve this connections and electronics are provided for allowing individual addressing of each pixel with data relevant to the image. The connections for data transfer may be by cable or wire or may be wireless. Power to the display modules may be by cable or energy scavenging techniques may be used, e.g. solar cells on the display modules.

The embodiment depicted in FIG. 1 comprises five light emitting and/or light reflecting surfaces 130. In different embodiments of the invention, another number and/or another arrangement of these surfaces 130 may be used. It is not a scope of the present invention to rely on the strict number of five light emitting surfaces 130.

Furthermore, the front face 160 comprises an anti-glare structure 140 covering a second partial area of the front face 160. The anti-glare structure comprises a plurality of dome-shaped members protruding from the front face 160. Any of said dome-shaped members 200 has a diameter ranging from 1.0 mm up to 3.0 mm. Experiments have shown that this range provides a low level of light reflection creating a surface that appears black when viewed. The dome-shaped members may be made from the same material than the base material 110 or from a different material, e.g. they could be made from an elastomer or polymer. The surface of the domes may be matt or non-reflective, e.g. they may be buffed in order to create a surface roughness. In the latter case, the dome-shaped members may be joined to the base material 110 by means of a welding process, a gluing process, or a mechanical connection process such as clipping, screwing, riveting or the like. In a preferred embodiment, the dome-shaped members 200 are formed as an integral part of the base material 110. This may be achieved by means of a moulding process.

The back side of the base material 110 may be designed to accommodate an electrical connector such as a plug. The connector may be used to power up a light emitting surface 130 by means of a respective electrical control signal. The connector may be designed to be joined with a cable or a backplane comprising a plurality of electrical conductors and a plurality of connectors at the positions intended for accommodating a display module 100.

In order to protect the light emitting surfaces 130 and the anti-glare structure 140, a transparent cover 150 is provided. The transparent cover may be made from glass, polycarbonate, PMMA, polyethylene or the like. It may be joined to the base material by means of a welding process or using a resilient seal 120 which may comprise polysiloxane, EPDM, FPM, or the like. The seal 120 and the transparent cover 150 may protect the front face 160 of the display module 100 against water and dust ingress.

In another embodiment of the invention, any of the light emitting and/or light reflecting surfaces 130 may be protected by an additional seal 125 which is arranged between the front face 160 of the display module and the transparent cover 150. The additional seal 125 will give an additional protection of the light emitting and/or light reflecting surfaces 130 in case of a failure of the outer seal 120.

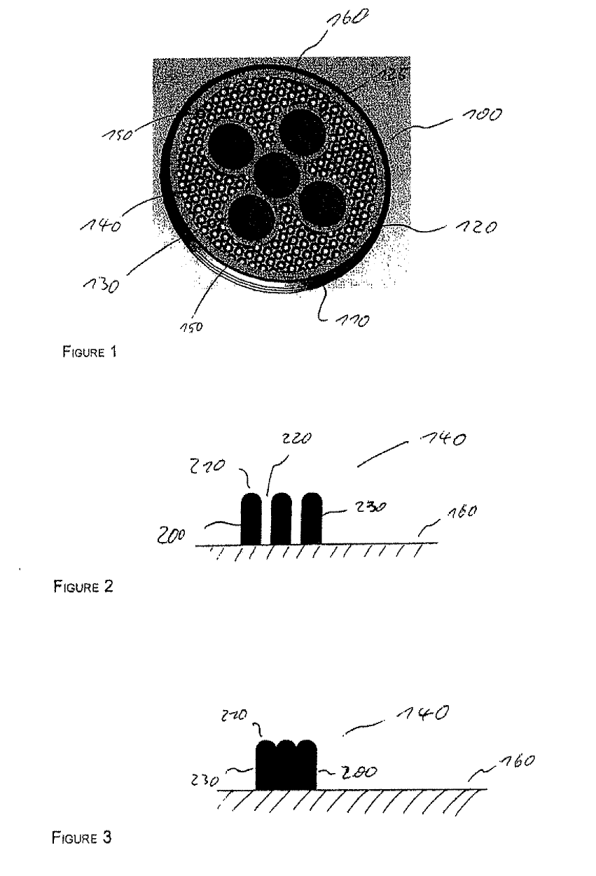

With respect to FIG. 2, the mode of operation of the anti-glare structure 140 is explained. FIG. 2 shows a cross sectional view on three dome-shaped members 200 which are part of the anti-glare structure 140. It is apparent to one skilled in the art that the anti-glare structure is not limited to three dome-shaped members shown in FIG. 2. However, the dome-shaped members 200 may cover the second partial area of the front face 160 completely.

The dome-shaped members 200 has a diameter ranging from 1.0 mm up to 3.0 mm. The dome-shaped members 200 protrude from the front face 160 and form column-like structures with a straight side face 230.

On top of the dome-shaped members 200, a curved surface 210 is provided. The curved surface 210 has the effect of defocusing the reflected light, i.e. the reflecting area on top of the dome visible by a single member of the audience looking at the display module becomes very small. As the curved surface 210 is symmetrically arranged on top of the dome-shaped member 200, this effect is independent from the viewing angle and therefore independent from the orientation of the display module 100. The sides of the domes also reflect little light due to their steep angle that is nearly perpendicular to the base material. The regions at the base of the domes is hidden from view. Preferably, the height of the domes is in the range 3 to 15 mm, e.g. 5 to 10 mm.

The size of the dome-shaped members is a critical parameter. It should be understood that all black plastics material and most black rubbers reflect light. If the curved surface 210 becomes too large and/or the curvature becomes to small, highlights of the top of the surface 210 can develop which can be seen as reflections by a user. If the dome-shaped members 200 become too small, each dome-shaped member 200 can be seen as a dot of reflected light. It has been discovered that an optimum may be seen if any of said dome-shaped members has a diameter ranging from approximately 1.0 mm up to approximately 3.0 mm. In another embodiment of the present invention, any of said dome-shaped members has a diameter ranging from 1.5 mm up to 2.5 mm.

The embodiment depicted in FIG. 2 shows a gap 220 between two adjacent dome-shaped members 200. It is preferred that the diameter of this gap 220 is smaller than its height. This will allow for light reflected on the bottom of the gap on the front face 160 to be absorbed by multiple reflections on the side faces 230 of the dome-shaped members 200.

As FIG. 2 depicts only a cross sectional view of the dome-shaped members 200 in one single direction, the base area of the dome-shaped members cannot be seen from FIG. 2. It base area may have the form of a circle, giving the dome-shaped members 200 substantially the form of a cylinder. In another embodiment of the invention, the base area may have a polygonal form, giving any of the dome-shaped members 200 the form of a prism. In still another embodiment, a plurality of differently formed dome-shaped members 200 may be arranged on the same front face 160 of single display module 100.

FIG. 3 shows another embodiment of the anti-glare structure 140. According to the embodiment depicted in FIG. 3, the spacing of two adjacent dome-shaped members 200 equals the diameter of said dome-shaped members. This means that the gap 220 present in FIG. 2 is omitted in this embodiment. This feature has the effect that the front face 160 may be covered completely with dome-shaped members 200, thereby allowing no light to be reflected at the front face 160. Therefore, the contrast of an image displayed at the display module 100 may be increased.

FIG. 4 shows another embodiment of the anti-glare structure 140 according to the present invention. The anti-glare structure 140 according to FIG. 4 comprises a plurality of dome-shaped members 200 having a bevel side face 430. The bevel side face 430 results in the gap 420 being formed between two adjacent dome-shaped members 200 at their top end located distant from the front face 160. However, as the base area of any of the dome-shaped members 200 is larger than the curved surface 210 at the top, the base surfaces of two adjacent dome-shaped members 200 still may touch each other. The bevel side face 430 has the effect that the anti-glare structure 140 according to FIG. 4 may be obtained by moulding in a more reliable and easier manner. In order to achieve this object of the invention, the bevel side faces 430 may be sloped about 0.5 degrees up to 5 degrees, in particular about 1 degree up to 2 degrees according to different embodiments of the invention.

It has to be noted that the base area of the dome-shaped members 200 according to the embodiment illustrated in FIG. 4 may be round, thereby giving any of the dome-shaped members 200 the form of a cone. In another embodiment of the invention, any of the dome-shaped members may have a polygonal base area, thereby giving any of the dome-shaped members 200 the form of a pyramid. In case of a polygonal base area, the dome-shaped members 200 might be arranged closer together and thereby giving a more complete cover of the second partial area of the front face 160. In order to achieve this aim, the dome-shaped members 200 may have differently formed base areas.

In order to allow the display of colour graphics using the display module, a plurality of light emitting diodes covering different basic colours such as red, green and blue are provided on a single light emitting surface 130. The sense of colour for a user is improved when three light emitting diodes representing three colours are arranged as close as possible to each other. This can be achieved by means of a plurality of light emitting diodes being arranged in a single package and/or on a single semiconductor dye, giving a three colour LED.

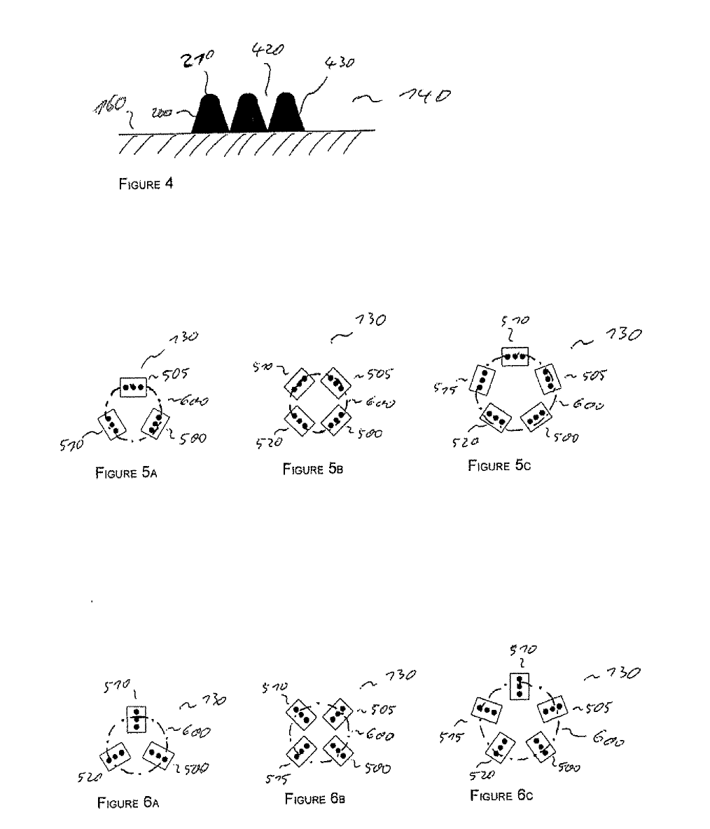

In order to increase the intensity of light emitted by every light emitting surface 130, a plurality of three colour LEDs may be arranged on a single light emitting surface 130. FIG. 5 gives three preferred arrangements for a plurality of light emitting diodes on a single light emitting surface 130. The basic concept as represented in FIGS. 5a, 5b and 5c comprises an arrangement on a circle 600, wherein any of the elongated three colour LEDs is arranged tangential to the virtual circle 600. When arranging three light emitting diodes 500, 505 and 510 on a circle 600 such as a depicted in FIG. 5, this arrangement may also be called a triangular arrangement.

In the same way, an arrangement of four light emitting diodes 500, 505, 510 and 520 being arranged on a circle 600 as depicted in FIG. 5b can be called a quadrangular arrangement.

As can be seen from FIG. 5c this circular or polygonal arrangement is not limited to three or four light emitting diodes, but can also be applied to any higher number of light emitting diodes such as five or more light emitting diodes. The arrangement shown in FIG. 5 provides the advantage that the colours are cut off equally and acceptable viewing angles are independent of the orientation of the module. Due to the arrangement depicted in FIG. 5, a user looking at the display showing a white image will encounter no colour loss and therefore has the impression of a white image. When not orienting the light emitting diodes in the shown manner, the colours may be cut off unequally and therefore some pixels would look more blue and others more red at extreme viewing angles, i.e. viewing angles greater than 45 degrees. Accordingly such arrangements are suitable for use with the variable geometry frames in accordance with other embodiments of the invention which present the light modules at a variety of angles and positions.

As shown in FIG. 6, the effect detailed with respect to FIG. 5 can also be achieved when every light emitting diode in the circular arrangement is turned through 90 degrees. As an exemplary embodiment, FIG. 6a shows a triangular arrangement of three light emitting diodes 500, 510 and 520, which are distributed equally on a circle 600. FIG. 6b shows a quadrangular arrangement of four light emitting diodes 500, 505, 510 and 515 which are distributed equally on a circle 600. FIG. 6c shows the similar arrangement for five light diodes 500, 505, 510, 515 and 520.

As detailed with respect to FIG. 5, the invention does not rely on an arrangement comprising three, four or five light emitting diodes, but also higher numbers of light emitting diodes might be useful. The arrangement shown in FIGS. 6a to 6c has the advantage, that a higher number of light emitting diodes can be arranged on a given surface, thereby achieving a higher light intensity and a brighter image but still maintaining a broad viewing angle.

To increase the light intensity further, any of the arrangements shown in FIGS. 5a, 5b, 5c, 6a, 6b or 6c can be completed by adding an additional light emitting diode in the centre of circle 600.

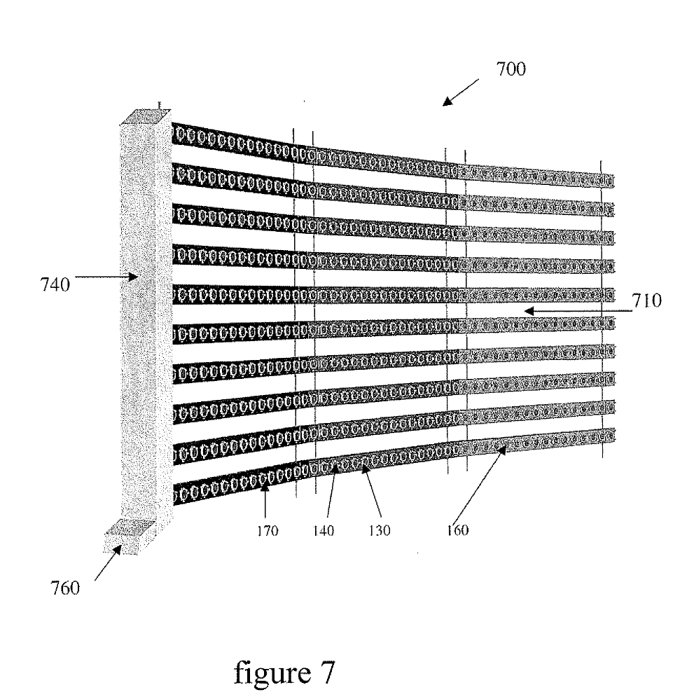

A display apparatus 700 comprising a plurality of display modules 100 is explained with respect to FIG. 7. The display apparatus 700 comprises a housing or frame with a front face 710. The display apparatus 700 can be set to a desired curved shape using the frame. Various frames can be chained together to form a plurality of display apparatuses 700 thus forming an even larger display.

On the front face 710, a plurality of display modules 100 is arranged. The display modules 100 are arranged such that the front faces 160 of the display modules 100 are facing towards a user being located in front of the front face 710. As shown in FIG. 7 the modules are shown in rows but the present invention also includes that the modules may be arranged in columns or in rows and columns. The frame made of rows can be secured by vertical pillars, pylons or stands to which the rows are attached. These vertical pillars, pylons or stands should be locatable at any suitable position in order to follow the curve of the rows. Where the modules are arranged in vertical strips or ribbons, each of the ribbon or strip may be hung from a ceiling, frame or gantry. Where the modules are arranged in horizontal strips or ribbons, each of the ribbon or strip may also be hung from a ceiling, frame or gantry.

Every front face 160 of every display module 100 comprises at least one light emitting surface 130. Any of these light emitting surfaces 130 may comprise at least one light emitting diode 500. In case that more than one light emitting diode 500 is present on a light emitting surface 130, these LEDs may be arranged as detailed with respect to FIG. 5 or 6. In order to display a large image, the image is split into a plurality of pixels as known in the art. Every pixel is intended to be displayed by at least one display module 100, depending on the resolution of the image to be displayed and the number of display modules being present on the display apparatus 700 and the number of display apparatuses 700 used. To achieve this aim, electronics are provided which are useful to control the light emitting diodes on the light emitting surfaces 130. These electronics may comprise power supplies, digital memories, a microprocessor, switching devices or the like. To achieve this connections and electronics are provided for allowing individual addressing of each pixel with data relevant to the image. The connections for data transfer may be by cable or wire or may be wireless. Power to the display modules may be by cable or energy scavenging techniques may be used, e.g. solar cells on the display modules.

In order to provide an optimized contrast, the front faces 160 of the display modules 100 comprise an anti-glare structure 140 as detailed above. In one embodiment of the invention, the front face 710 of the display apparatus 700 may additionally comprise an anti-glare structure 170 on the surface areas which are not covered by a display module 100. The anti-glare structures 170 preferably comprise a black material such as a plurality of dome-shaped members 200 as detailed with respect to FIGS. 2 to 4.

In order to provide signals representing an image to be displayed and/or electric energy for operating the light emitting diodes being part of the light emitting surfaces 130, an electrical connector 740 is provided on the display apparatus 700. This electrical connector 740 may be arranged on the side surface of the display apparatus 700 and may be adapted to accommodate a corresponding socket 760 on the bottom surface. In another embodiment of the invention, a plug may be arranged on the back side of the display apparatus 700 in order to establish a cable connection or a connection to a back plane.

In accordance with one embodiment of the present invention, a curve creator is provided that is able to control the curvature of a flexible device that can be used as a variable geometry frame to which lighting or display elements may be attached. Thanks to the curve creator mechanism, a flexible device can be bent and locked into a certain curvature. It is also possible to adjust the radius of the curvature. An important feature of this curve creator is that is makes the flexible entity, that needs to be bent, not much bigger than the size required for mechanical stability, thanks to its compact construction.

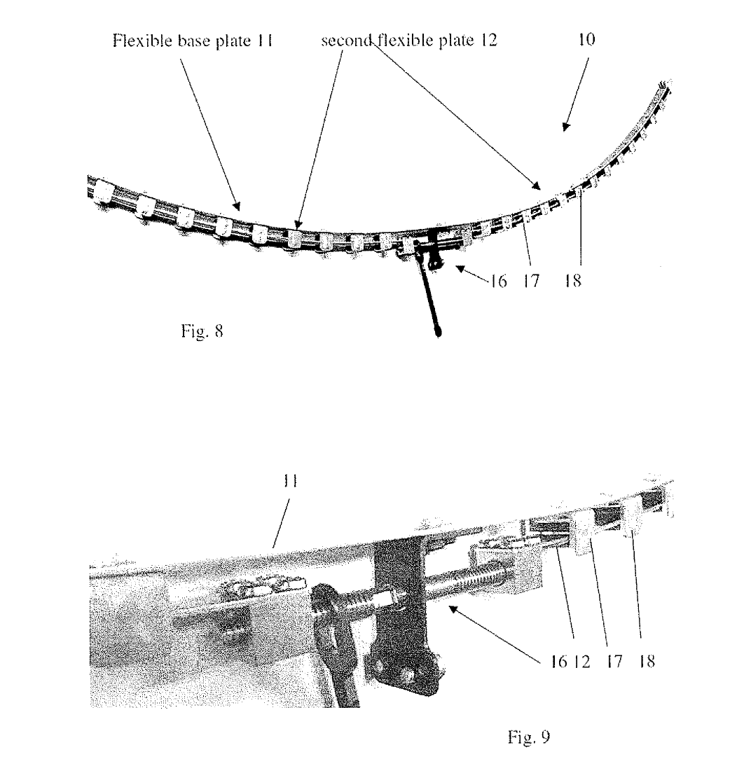

As shown schematically in FIG. 8 the curve creator 10 comprises a flexible elongate base plate or beam 11 that acts as frame. A second flexible elongate device 12 is attached at both ends of the plate or beam or at intermediate positions along the plate or beam. The flexible elongate device 12 is kept parallel with the flexible elongate plate or beam 11 by guides 17, 18 etc. This device 12, i.e. the flexible plate, a chord, . . . can be shortened and eventually lengthened by means of a length altering mechanism. As the flexible elongate device 12 is enclosed over its whole length by the guides 17, 18, etc. it's distance to the base plate 11 cannot vary. Lengthening or shortening the second device 12, makes the curve creator assume a convex or concave form, without loosing its compactness, and this by only one action.

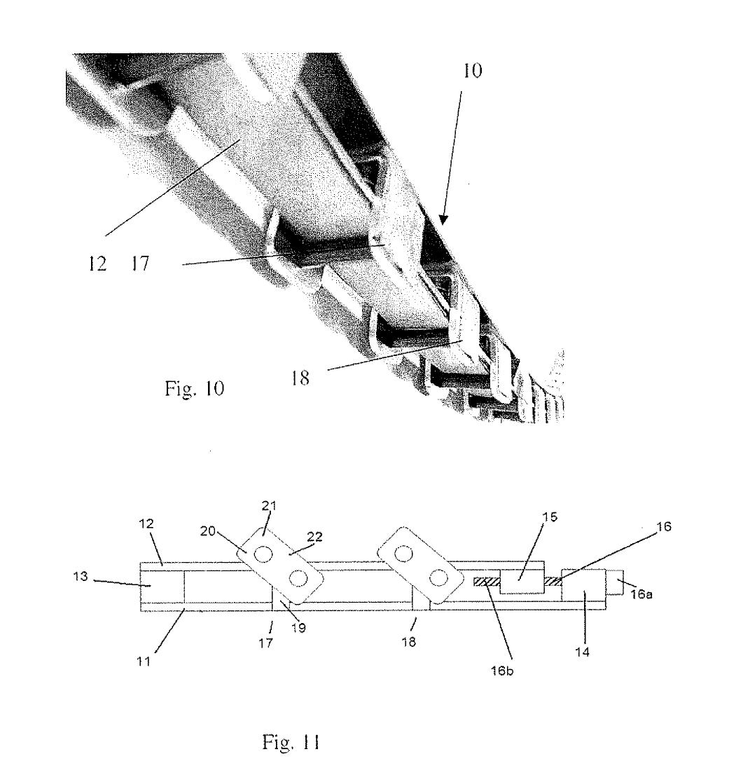

In one embodiment, the base plate 11 and the flexible device 12 are made out of metal and the lengthening device 16 is formed from a screw as shown schematically in FIGS. 8 and 9. FIG. 9 shows a detail of the screw 16 as lengthening device described in detail below. The screw 16 may be part of a bottle screw or turnbuckle. FIG. 10 shows a detail of how the second flexible plate 12 is enclosed to keep its distance to the base plate 11 constant.

A display screen can be made up of a number of curve creators arranged in parallel, e.g. in rows or columns. This curve creator can be used to force an LED video screen into a curvature as shown schematically in FIG. 7. The curve creator is assembled onto individual panels that form a large screen when assembled together.

FIG. 11 shows an embodiment of the present invention that can be used to form the curve creator described above. A beam 10 (shown in FIG. 11) comprises two strips 11 and 12 facing each other. Strip 12 may be shorter than strip 11. The strips 11, 12 can be made of a flexible material such as metal or plastic. Strip 11 and 12 may be made out of different materials but for the sake of clarity, it will be assumed that they are both made out of the same material e.g. steel or aluminium. Both strips are flexibly elastic or ductile enough to be bent “around” a direction perpendicular to the plane of FIG. 11.

The strips are maintained at a given distance of each other through guide elements 17, 18 . . . Elements 13 may be a block of material with a form substantially that of a parallelepiped. If its properties allow for it, element 13 may be fastened, e.g. soldered or welded or glued or riveted, to the strips 11 and 12 at a first end of both strips. Elements 11, 12 and 13 may also be assembled by other means (e.g. bolts and nuts, . . . )

Elements 17, 18 . . . are placed preferably at regular intervals along the strips to maintain them at a given (and more or less constant) distance apart in spite of stresses that might be applied to the strips. Each of the elements 17, 18 . . . comprises a set of “feet” elements 19 that are fastened, e.g. welded, soldered, glued, riveted, or screwed, to the longer strip 11. Each of the elements 17, 18 also comprises a set of support elements 20 fastened, e.g. soldered, welded, riveted, glued, screwed to the feet 19. A set of axles, e.g. rods or cylinders (21, 22) join both support elements 20 and define an aperture wide enough to allow the shorter strip 12 to pass through them. The axles may be hollow or solid, other types of rods or cylinders with non-circular section can also be used. The axles (21, 22) may be fastened, e.g. soldered, welded, glued, screwed, riveted to the support elements 20 or if the axles (21, 22) have a circular cross section they may rotate freely within circular openings made in the elements 20. The axles 21, 22 may touch/contact the strip 12 but do not prevent the strip 11 from sliding through the opening that they define and through which the strip 12 passes.

An element 14 similar in shape and size to element 13 is fastened at a second end of strip 11. An element 15 similar in shape and size to element 13 is fastened at a second end of strip 12.

A “screw” 16 extends through block 14 and 15 in a direction parallel to (the major dimension/the length of) the strips. The screw 16 has two threads: a first thread in the region closer to the head 16a of the screw and a second thread closer to the other end 16b of the shaft of the screw. Both threads have opposite handedness so that when rotated along its axis the screw will either increase or decrease the distance between elements 14 and 15. This device for changing the length of the second strip is often called a turnbuckle or bottle screw. Let us call first direction of rotation, the direction in which the screw must be turned to decrease the distance between elements 14 and 15 and second direction of rotation the direction in which the screw must be turned to increase the distance between elements 14 and 15.

When turned in a first direction of rotation, the screw will decrease the distance between elements 14 and 15. As a result, the strip 12 will be put in extension and the strip 11 will be put in compression. Strip 11 and 12 being kept at a more or less constant distance of each other along their length thanks to elements 13, 17, 18 . . . they will both then to bend around the same direction perpendicular to the plane of FIG. 1.

When turned in a second direction of rotation, the screw will increase the distance between elements 14 and 15. As a result, the strip 12 will be put in compression and the strip 11 will be put in extension. Strip 11 and 12 being kept at a more or less constant distance of each other along their length thanks to elements 13, 17, 18 . . . they will both tend to bend around the same direction perpendicular to the plane of FIG. 1.

The radius of curvature along the strips as well as an angle α between the tangents to the strips at both extremities of the strips is a function of the distance imposed by the screw 16 between the elements 14 and 15.

By varying the distance between the elements 14 and 15 of the beam 10 as discussed here above, the supports 100 will move and generate a (portion of a) cylindrical surface forming a curve that includes the segment of curve whose shape is assumed by the beam 10. The proposed mechanism 10 when assembled to supports 100 as proposed here above solve thus the problem of generating a non plane “light wall” without encumbering space with cables spanned between the extremities of the “light wall”. The light wall may be either convex or concave (as seen by an observer looking at the lights dispersed across the light wall)

Several beams similar or identical to the beam 10 may be fastened to the supports 100 to generate more complex surfaces, i.e. to form a display surface as shown schematically in FIG. 7.

To ensure a greater rigidity of the assembly (10+100) of supports 100, one or more strips of ductile material (20, 30 . . . ) may be fastened to the supports 100.

In another embodiment, the beam itself may be used as a direct support for the lamps by filling the spaces between strips 11 and 12 with lamps (typically LEDs, LED modules).

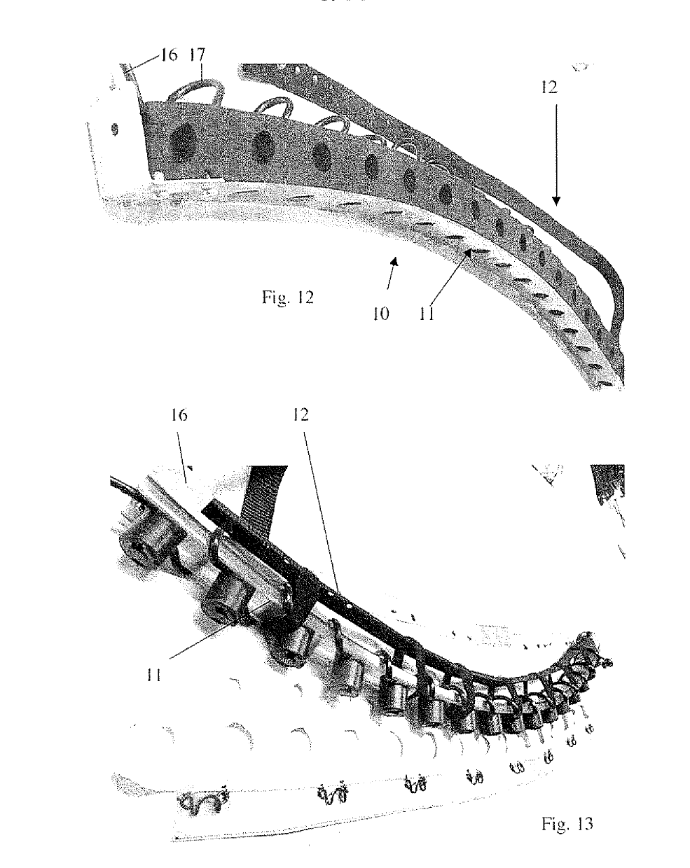

Another embodiment of the present invention includes a curve creator 10 comprising an elongate plastic construction base 11 having connections for display elements, e.g. lighting, lamps etc., with a ribbon or chord tensioner 12 as shown in FIGS. 12 and 13. The ribbon or chord is constrained to remain close to or substantially parallel to the base 11 by guides 17, 18 that can be in the form of rings. A device is provided for changing the length of the tensioner, e.g. a locking device such that the tensioner can be pulled by hand or by other pulling equipment and then locked under tension.

When using a preformed concave base 11, concave and convex forms can be made only by using a pull force on the tensioner 12. In this design this force is obtained by pulling the ribbon 12 attached to the other end of the base plate 11.

When the ribbon 12, attached to one end of the base 11, is pulled at the other end, the curve creator gets a convex shape. In this design, a video LED screen can be built up out of individual strips 11, 12 as shown for instance in FIG. 7.

Optionally, a common power bus/cable will be laid along the base 11 of any of the embodiments described above of the curve creator to feed/power the lamps/LED modules/LEDS. Depending on the required power to be delivered to the lamps, the section of the cable may increase in such measure that it will increase the rigidity of the base 11 (a) making it harder to bend and hence more strenuous/arduous/difficult to install (b) being more rigid, the cable itself may impose a minimum radius of curvature (in order not to break/decrease reliability) not compatible with the radius of curvature required for a given light displays. The problem is solved for a given power rating of the bus by increasing the voltage at which power is delivered to the lamps (this decreasing the intensity of the current that will circulate through the power bus) and decreasing it locally/at the level of each lamp with the help of a DC-DC converter.

The base 11 of any of the embodiments of the curve creator may be fastened to a series of supports, each support may be accommodating lamps, display elements or lighting, whether the lamps are light bulbs, LED modules, etc. in a frame as shown in FIG. 7. Every front face of every display element such as lamps, display elements or lighting comprises at least one light emitting surface. Any of these light emitting surfaces may comprise at least one light emitting diode. In case that more than one light emitting diode is present on a light emitting surface, these LEDs may be arranged as detailed with respect to FIG. 5 or 6. In order to display a large image, the image is split into a plurality of pixels as known in the art. Every pixel is intended to be displayed by at least one display element, depending on the resolution of the image to be displayed and the number of display elements being present on the display apparatus 700 and the number of display apparatuses 700 used. To achieve this aim, electronics are provided which are useful to control the light emitting diodes on the light emitting surfaces. These electronics may comprise power supplies, digital memories, a microprocessor, switching devices or the like. To achieve this connections and electronics are provided for allowing individual addressing of each pixel with data relevant to the image. The connections for data transfer may be by cable or wire or may be wireless. Power to the display modules may be by cable or energy scavenging techniques may be used, e.g. solar cells on the display modules.

In order to provide an optimized contrast, the front faces of the display elements comprise an anti-glare structure as detailed above. In one embodiment of the invention, the front face 710 of the display apparatus 700 may additionally comprise an anti-glare structure on the surface areas which are not covered by a display element. The anti-glare structures preferably comprise a black material such as a plurality of dome-shaped members 200 as detailed with respect to FIGS. 2 to 4.

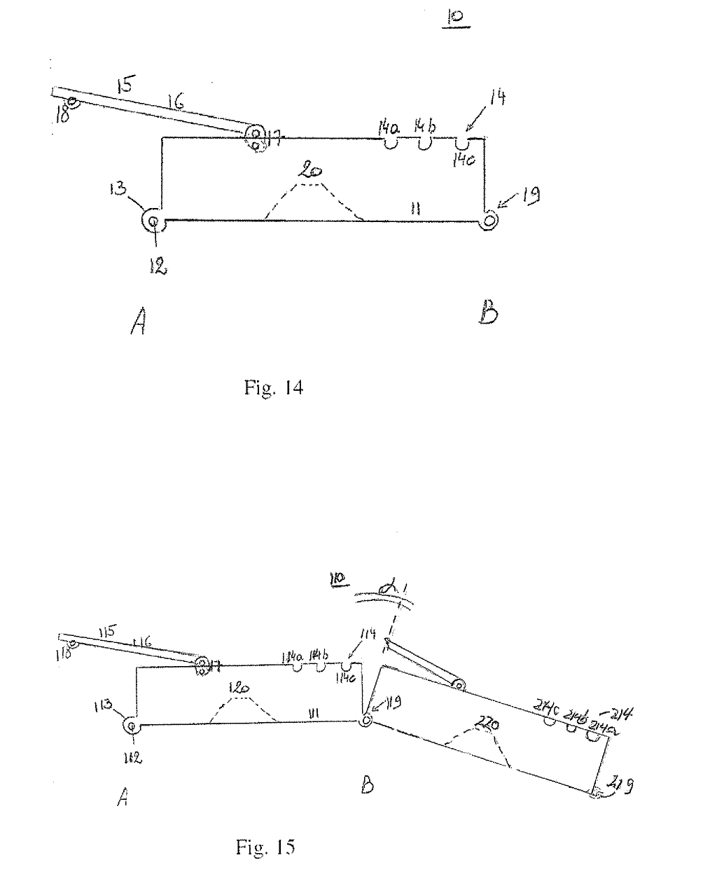

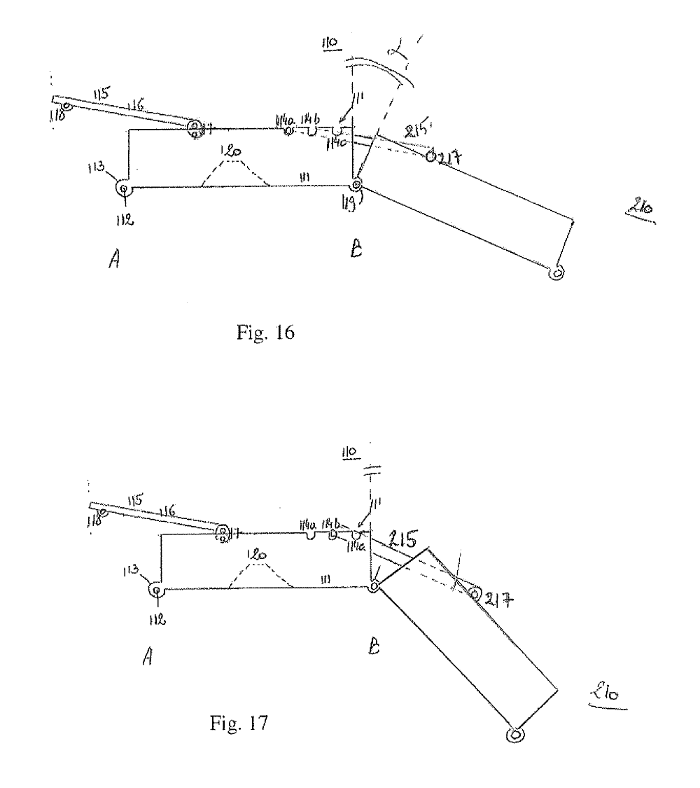

In accordance with a further embodiment of the present invention a variable geometry frame for lighting or display elements is constructed from modular articulated units. As shown in FIGS. 14 to 17. A polygonal frame in the form of a stand or support is constructed from modular articulated light modules, each light support module 10 comprising a main body 11 which can have a rectangular shape with four corners and four edges, a pivot pin/a pivot shaft 12 located at or adjacent to the bottom corners of the main body 11 to support rotation of a light support module with respect to an adjacent module, and a first set hole or set of holes 13 in the main body part 11 for receiving pivot shaft 12. A rack or notched part 14 is formed in the main body on an first edge opposite to that of the holes 13 and having a plurality of notches 14a, 14b, 14c, along the first edge. A locking mechanism 15 comprises an elongate element 16. A second hole or set of holes 19 is provided in the body part 11 on the other bottom corner for receiving the pivot shaft of another light support module. A light module 20 can be located into the main body on the same side as the holes 13 and 19 for example with the light shining downwards in the figure.

In particular the pivot shaft 12 is at a first end (A) of the light support module 10/body part 11. The second set of holes 19 is at a second end (B) of the light support module 10/body part 11. The rack notched part is at the second end (B) of the light support module/body part 11. The locking mechanism is at the first end (A) of the light support module/body part 11.

The locking mechanism 15 comprises e.g. a bar or plate 16 rotating around a pivot shaft 17 fastened to the body part 11 and comprising a pawl or a shaft or a pin 18 susceptible to engage and lock itself into the rack/notch part of another light support module.

Several modules can be assembled to realize a curved light support see FIGS. 15 to 17. For instance, the second set of holes 119 in the body part 111 of a first light module 110 may be received around the pivot shaft 212 of a second light module 210. Once assembled the series of modules forms one of the rows or columns of the display of FIG. 7.

As long as the locking mechanism 215 of the second light module is not engaged in the rack/notched part 114 of the first light module, the angle alpha between the two light modules varies and the structure can be adjusted to the appropriate angle for e.g. a wall of lights.

By engaging the locking mechanism 215 into the rack 114, e.g. by “mating” the shaft/pin 218 into one of the notches 114, the angle alpha is determined and may not vary until the locking mechanism is released. One predetermined value of the angle alpha can be realized for each notch that the notched part 114 comprises.

The articulated modules can be fastened together in a series to form a ribbon or strip and these ribbons or strips may be attached to supports or hung from a frame, gantry or ceiling. The articulated modules thereby form a polygonal surface and may accommodate lamps, display elements or lighting, whether the lamps are light bulbs, LED modules, etc., e.g. in a frame as shown in FIG. 7. Every front face of every display element such as lamps, display elements or lighting comprises at least one light emitting surface. Any of these light emitting surfaces may comprise at least one light emitting diode. In case that more than one light emitting diode is present on a light emitting surface, these LEDs may be arranged as detailed with respect to FIG. 5 or 6. In order to display a large image, the image is split into a plurality of pixels as known in the art. Every pixel is intended to be displayed by at least one display element, depending on the resolution of the image to be displayed and the number of display elements being present on the display apparatus 700 and the number of display apparatuses 700 used. To achieve this aim, electronics are provided which are useful to control the light emitting diodes on the light emitting surfaces. These electronics may comprise power supplies, digital memories, a microprocessor, switching devices or the like. To achieve this connections and electronics are provided for allowing individual addressing of each pixel with data relevant to the image. The connections for data transfer may be by cable or wire or may be wireless. Power to the display modules may be by cable or energy scavenging techniques may be used, e.g. solar cells on the display modules.

In order to provide an optimized contrast, the front faces of the display elements comprise an anti-glare structure as detailed above. In one embodiment of the invention, the front face 710 of the display apparatus 700 may additionally comprise an anti-glare structure on the surface areas which are not covered by a display element. The anti-glare structures preferably comprise a black material such as a plurality of dome-shaped members 200 as detailed with respect to FIGS. 2 to 4.

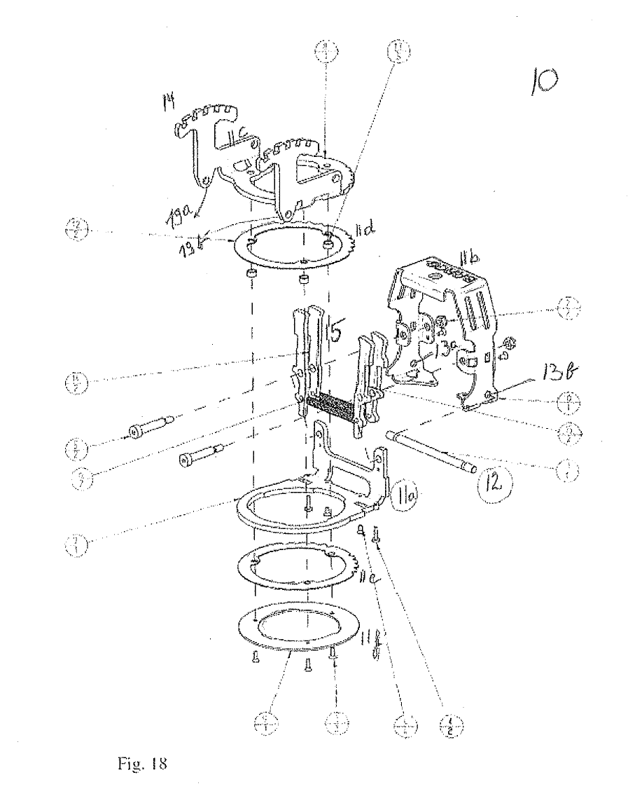

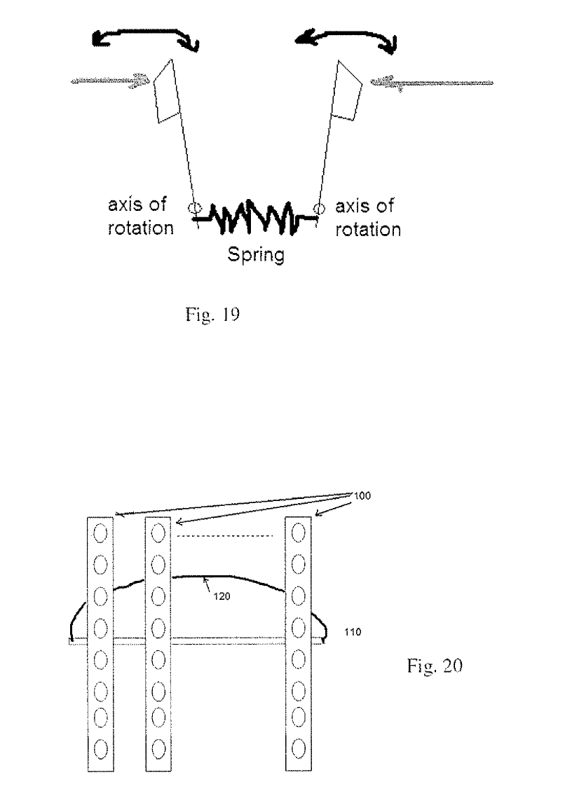

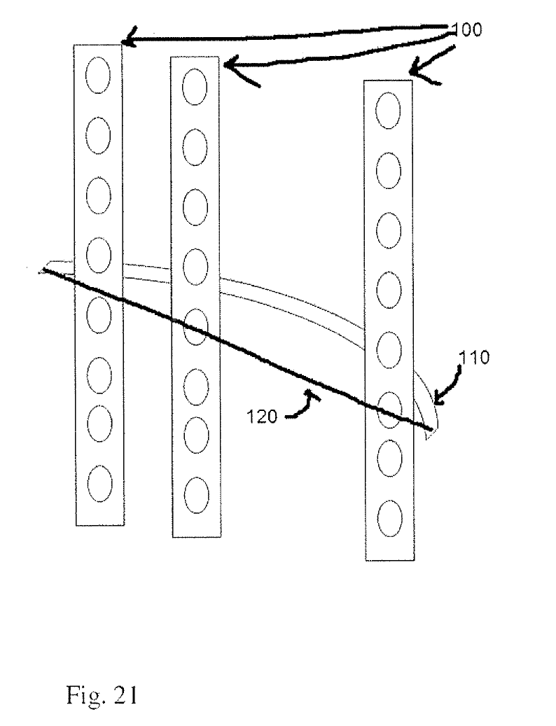

A further embodiment of the present invention of a display having modular articulated units for use to make a light stand or support comprises a string of light support modules 10 with two or more degrees of freedom as shown schematically in FIG. 18. A first light support module 10 comprises a first main body part (11a, 11b) and a second main body part (11c). The first main body part has two components—a light support component 11a and a locking frame 11b. The second main body part (11c) is used for locking one support module with reference to the adjacent module. A pivot pin/a pivot shaft 12 is provided to support rotation of an adjacent second light support module 10 (not shown in FIG. 18) with respect to the first light support module 10 about the pin or shaft 12. To enable this a first hole or set of holes (13a, 13b) is provided in the locking frame (11b) for receiving the pivot shaft 12. A curved rack/a notched part 14 with notches 14a, 14b, 14c . . . is provided on the second main body part (11c). Namely the second main body part has a circular base with two arms placed diametrically opposite to each other across the circular base and rising perpendicularly with respect to the plane of the circular base. On the top of these arms the notches 14 are located on an arcuate element.

A locking mechanism 15 is also provided and is fastened to the first main body part (11a, 11b). A second hole or set of holes (19a, 19b) in the second body part 11c are arranged to receive the pivot shaft of the adjacent second light support module. This adjacent second light support module is not shown in FIG. 18 but is located at the left-hand side of the first light support module 10 and its pivot shaft passes also through the corresponding hole or set of holes of the locking frame belonging to the adjacent second light support module.

In an analogous way, an adjacent third light support module (not shown in FIG. 18) may be located at the right-hand side of the first light support module 10. The second main body part of this third light support module is hingedly connected to the locking frame (11b) of the first light support module 10 by means of the pivot pin or shaft 12. In addition a light module 20 (not shown on figure) may be located below the first main body part (11a, 11b) but the light module may also be fixed to the second main body part 11c.

The first and second main body parts may rotate around a first common rotation axis and two adjacent modules may rotate about a second axis perpendicular to the first axis. For instance, both the light support component 11a and the second main body part 11c may have/may present a ring like structure. A first friction seal 11d (e.g. in Teflon) is placed between the ring like structure of body part 11c and the light support component 11a. A second friction ring 11e is placed between the ring like structure of the light support component 11a and a third ring like structure 11f. The ring 11f is fastened to the body part 11c with the help of fasteners (e.g. screws that extends through openings/holes through the ring 11f, the friction seals and 11a.) These fasteners pass through the open space within the ring of the light support component 11a, allowing a rotational movement of second main body part 11c with respect to the light support component 11a.

As already explained above, two such first and second light support modules may be assembled together by the shaft or pin 12 being located in the holes 19a, 19b of the second module and the holes 13a 13b of the first support module. In this way two modules are connected together but in such a way that they can rotate about the shaft or pin 12. Once the rotation has been set it may be locked in place by using the locking mechanism 15. The locking mechanism 15 includes locking arms that are forced apart by a spring located between the bases of the arms as shown schematically in FIG. 19. The heads of the arms locate through openings in the first body part 11b and locate in the notches 14 of the second body part 11c of the second light support module. In this way two modules are locked at an angle to each other and the first light support module is locked to a first settable orientation with respect to the second light support module.

The second main body part of one module may also rotate with respect to the first main body of that module. This rotation can be prevented by using appropriate fixing devices such as screws that block the movement. If the movement is allowed, the rotation can be locked by the locking mechanism 15 for example. For example the bottom ends of the arms of the locking device may lock into notches on ring 11e and/or on ring 11d and lock in this way the second body part 11c.

In this way the first main body part may be locked to a second settable orientation with respect to the second main body part. The locking into the first orientation and the locking in the second orientation is done by the same locking mechanism.

The light modules may be comprise e.g. one or more LED (Light Emitting Diodes). The light modules may be connected to the same power bus e.g. a cable that will snake from module to module. In order not to decrease the flexibility of the whole, the cable should preferably be as thin as possible. This is more and more difficult as the power that must be delivered by the power bus increases (e.g. when more and more modules are connected together). It may be advantageous to deliver the power at high voltage and down convert the voltage of the power bus at the level of each light module to make it compatible with the type of light source (e.g. LED) that is used in the light module. For that purpose electronics in each module may include a DC-DC converter.

The articulated modules of this embodiment can be fastened together in a series to form a ribbon or strip and these ribbons or strips may be attached to supports or hung from a frame, gantry or ceiling. The articulated modules thereby form a polygonal surface and may accommodate lamps, display elements or lighting, whether the lamps are light bulbs, LED modules, etc., e.g. in a frame as shown in FIG. 7. Every front face of every display element such as lamps, display elements or lighting comprises at least one light emitting surface. Any of these light emitting surfaces may comprise at least one light emitting diode. In case that more than one light emitting diode is present on a light emitting surface, these LEDs may be arranged as detailed with respect to FIG. 5 or 6. In order to display a large image, the image is split into a plurality of pixels as known in the art. Every pixel is intended to be displayed by at least one display element, depending on the resolution of the image to be displayed and the number of display elements being present on the display apparatus 700 and the number of display apparatuses 700 used. To achieve this aim, electronics are provided which are useful to control the light emitting diodes on the light emitting surfaces. These electronics may comprise power supplies, digital memories, a microprocessor, switching devices or the like. To achieve this connections and electronics are provided for allowing individual addressing of each pixel with data relevant to the image. The connections for data transfer may be by cable or wire or may be wireless. Power to the display modules may be by cable or energy scavenging techniques may be used, e.g. solar cells on the display modules.

In order to provide an optimized contrast, the front faces of the display elements comprise an anti-glare structure as detailed above. In one embodiment of the invention, the front face 710 of the display apparatus 700 may additionally comprise an anti-glare structure on the surface areas which are not covered by a display element. The anti-glare structures preferably comprise a black material such as a plurality of dome-shaped members 200 as detailed with respect to FIGS. 2 to 4.

While the invention as been illustrated and described in detail in the drawing and forgoing description, such illustration and description are to be considered illustrative or exemplary and not restrictive. The invention shall not be limited to the disclosed embodiments. Other variations to the disclosed embodiments can be understood and effected by those skilled in the art in practising the claimed invention, from a study of the drawings, the disclosure, and the appended claims. In the claims, the indefinite article “a” or “an” does not exclude a plurality. Any reference signs in the claims should not be construed as limiting in the scope.

1. An arrangement of a plurality of articulated display modules including a first and second display module, the first display module comprising:
a main body,
a hinged connection for connecting to the adjacent second display module,
a first locking mechanism for allowing the first display module to have a settable first orientation with respect to the second display module and for locking the first orientation between the first and second display modules; and
a connection for a display element.

2. The arrangement of claim 1, wherein the hinged connection allows rotation around a first axis and the main body includes a first part and a second part, the first part being rotatable about a second axis with respect to the first part, the second axis being perpendicular to the first axis.

3. The arrangement of claim 2, further comprising a second locking mechanism for allowing the first part to have a settable second orientation with respect to the second part and for locking the second orientation between the first and second parts.

4. The arrangement of claim 3 whereby the second locking mechanism is the same as the first locking mechanism

5. The arrangement according to claim 1, wherein each display element includes a DC-DC converter.

6. The arrangement according to claim 1, wherein a display element is in accordance with claim 12.

7. An arrangement for a plurality of display elements, comprising:
a first flexible strip having connections for the display elements, the first flexible strip having two ends,
a second flexible elongate element having two ends attached to the two ends of the first flexible strip,
means for changing the length of the second flexible elongate element between the attached two ends.

8. The arrangement of claim 7, further comprising a series of guide elements for constraining the second flexible elongate element to be parallel to the first flexible strip.

9. The arrangement of claim 7, wherein the means for changing the length is a turnbuckle or bottlescrew.

10. The arrangement of claim 7, wherein a display element includes a DC-DC converter.

11. The arrangement of claim 7, wherein a display element is in accordance with claim 12.

12. A display element, comprising:
a front face,
at least one light emitting and/or light reflecting surface being arranged on the front side of the front face and covering a first partial area of said front face, and an anti-glare structure covering a second partial area of said front face, wherein
the anti-glare structure comprises a plurality of dome-shaped members protruding from the front face.

13. The display element according to claim 12, wherein any of said dome-shaped members has a diameter ranging from 1.5 mm up to 2.5 mm or any of said dome-shaped members has a diameter ranging from 1.0 mm up to 3.0 mm.

14. The display element according to claim 12, wherein the spacing of two adjacent dome-shaped members equals the diameter of said dome-shaped members.

15. The display element according to claim 12, wherein the basic shape of the dome-shaped members is any of a cylinder, a cone, a pyramid or a prism.

16. The display element according to claim 12, wherein the anti-glare structure is integrally formed as part of the front face.

17. The display element according to claim 12, wherein the anti-glare structure is made from a plastics material.

18. The display element according to claim 17, wherein the plastics material comprises a dye.

19. The display element according to claim 12, wherein the anti-glare structure is formed by a moulding process.

20. The display element according to claim 12, wherein the light emitting surface accommodates at least one light emitting diode.

21. The display element according to claim 20, wherein the light emitting diode is capable of emitting light of three elementary colours.

22. The display element according to claim 21, comprising a plurality of light emitting diodes which are arranged in a circle.

23. The display element according to claim 22, wherein an additional light emitting diode is arranged in the centre of the circle.

24. The display element according to claim 12, wherein the front face is arranged behind a transparent cover.

25. The display element according to claim 24, wherein a resilient seal is arranged between the front face and the cover.

26. A display apparatus comprising a plurality of display elements as recited in claim 12.

27. A display apparatus comprising a plurality of arrangements as recited in claim 1 arranged in rows or columns.

28. A display apparatus according to claim 26, wherein any of the display elements is arranged to display one pixel of an image.

29. A method of modifying an arrangement of a plurality of articulated display modules including a first and second display module, the first display module comprising:
a main body,
a hinged connection for connecting to the adjacent second display module,
a first locking mechanism for allowing the first display module to have a settable first orientation with respect to the second display module and for locking the first orientation between the first and second display modules; and
a connection for a display element, the method comprising:
setting the first orientation and locking it, and
connecting a third display module to the second display module.

30. The method of claim 29, further comprising attaching a display element to the associated connection for the display element on any of the first to third display modules.

31. The method of claim 30, further comprising connecting up power and/or data cables to the display element.

32. The method of claim 29, wherein the main body of the display module includes a first part and a second part, the hinged connection allowing rotation around a first axis and the first part being rotatable about a second axis with respect to the first part, the second axis being perpendicular to the first axis, the method further comprising setting the first part at an orientation with respect to the second part.

33. The method of claim 32, wherein the display module has a second locking mechanism provided for allowing the first part to have a settable second orientation with respect to the second part and the method comprises: locking the second orientation between the first and second parts.
